(19) United States
(12) Patent Application Publication
(10) Pub. No.: US 2024/0003563 A1
(43) Pub. Date: Jan. 4, 2024

(54) METHOD FOR DETECTING AND CLEANING INDOOR AIR POLLUTION

(71) Applicant: Microjet Technology Co., Ltd., Hsinchu (TW)

(72) Inventors: Hao-Jan Mou, Hsinchu (TW); Chin-Chuan Wu, Hsinchu (TW); Yung-Lung Han, Hsinchu (TW); Chi-Feng Huang, Hsinchu (TW)

(73) Assignee: Microjet Technology Co., Ltd., Hsinchu (TW)

(21) Appl. No.: 17/884,950

(22) Filed: Aug. 10, 2022

(30) Foreign Application Priority Data
Jun. 30, 2022 (TW) 111124544

(51) Int. Cl. F24F 11/00; G01N 15/00; F24F 8/158; F24F 8/167; F24F 8/22; F24F 8/24; F24F 8/30; F24F 11/56; F24F 11/63; F24F 11/79; F24F 11/89

(52) U.S. Cl. CPC F24F 11/0001; G01N 15/00; F24F 8/158; F24F 8/167; F24F 8/22; F24F 8/24; F24F 8/30; F24F 11/56; F24F 11/63; F24F 11/79; F24F 11/89; G01N 2015/0046; F24F 2110/64

(57) ABSTRACT

A method for detecting and cleaning indoor air pollution is disclosed. The method includes steps of providing a plurality of gas detection devices disposed in an indoor space for detecting a property and a concentration of an air pollution, wherein the plurality of gas detection devices detect the air pollution to output air pollution data, perform an intelligent computation to determine a location of the air pollution, and intelligently and selectively issue a controlling instruction; and providing a plurality of physical or chemical filtration devices, each of the plurality of physical or chemical filtration devices including at least one fan and at least one filter element, wherein the fan is enabled by the controlling instruction to generate a directional airflow convection for guiding the air pollution to pass through the filter element, thereby filtering and cleaning the air pollution to generate a clean and safely breathable air state.

### FIELD OF THE INVENTION

The present disclosure relates to a method for detecting and cleaning indoor air pollution, and more particularly to a method for producing a directional airflow convection in an indoor space for cleaning air pollution.

### BACKGROUND OF THE INVENTION

In recent years, people pay more and more attention to the air quality around their living environment. Particulate matter (PM), such as PM₁, PM_{2.5} and PM₁₀, carbon dioxide, total volatile organic compounds (TVOC), formaldehyde and even suspended particles, aerosols, bacteria and viruses contained in the air which are exposed in the environment might affect human health, and even endanger people's life in severe condition.

However, it is not easy to control the indoor air quality. In addition to the air quality of the outdoor space, the air conditions and pollution sources in the environment, especially the dusts originated from poor air circulation in the indoor space, are also the major factors that affect indoor air quality. In order to improve the indoor air environment and obtain good air quality quickly, various devices, such as air conditioners or air purifiers, are usually utilized to improve the indoor air quality.

Therefore, in order to intelligently and quickly detect the air pollution in the indoor space, effectively remove the indoor air pollution to generate a clean and safely breathable air state, instantly monitor the indoor air quality, and quickly purify the indoor air when the indoor air quality is poor, it becomes the major issue of the present disclosure to find a solution to intelligently generate an airflow convection in the indoor space, quickly detect and locate the air pollution, and effectively control a plurality of filtration devices to generate an intelligent airflow convection and accelerate the airflow in an desired direction(s), so as to filter and remove air pollution sources in the indoor space for cleaning the air pollution and obtaining a clean and safely breathable air state.

### SUMMARY OF THE INVENTION

One object of the present disclosure is to provide a method for detecting and cleaning indoor air pollution. After widely disposing a plurality of gas detection devices to identify the property, the concentration and the location of the air pollution, and performing various mathematical operations and artificial intelligence operations by a cloud device through wired and wireless networks to determine the location of the air pollution, the physical filtration device or the chemical filtration device closest to the location of the air pollution is intelligently selected and enabled to generate an airflow, so that the air pollution can be quickly guided to at least one physical filtration device or at least one chemical filtration device for being filtered and cleaned, thereby generating a clean and safely breathable air state, so as to achieve the effects of air pollution-locating, air pollution-draining and air pollution-cleaning.

In accordance with an aspect of the present disclosure, a method for detecting and cleaning indoor air pollution is provided. The method includes steps of providing a plurality of gas detection devices disposed in an indoor space for detecting a property and a concentration of an air pollution, wherein the plurality of gas detection devices are provided to detect the air pollution and output air pollution data; performing an intelligent computation to determine a location of the air pollution in the indoor space, and intelligently and selectively issue a controlling instruction; and providing a plurality of physical filtration devices or a plurality of chemical filtration devices, each of the plurality of physical filtration devices or the plurality of chemical filtration devices including at least one fan and at least one filter element, wherein the fan is enabled by the controlling instruction so as to generate a directional airflow convection through performing a mathematical operation for guiding the air pollution to pass through the filter element, so that the air pollution in the indoor space is filtered and cleaned to generate a clean and safely breathable air state.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a schematic view illustrating the concept of how to perform a method for detecting and cleaning indoor air pollution in an indoor space according to an embodiment of the present disclosure;

FIG. 2A is a schematic view illustrating a fan and a filter element of a filtration device for performing the method for detecting and cleaning indoor air pollution according to an embodiment of the present disclosure;

FIG. 2B is a schematic view illustrating the filter element according to the embodiment of the present disclosure;

FIG. 3 is a schematic perspective view illustrating a gas detection device according to an embodiment of the present disclosure;

FIG. 4A is a first schematic perspective view illustrating a gas detection main part according to an embodiment of the present disclosure;

FIG. 4B is a second schematic perspective view illustrating the gas detection main part according to the embodiment of the present disclosure;

FIG. 4C is an exploded view illustrating the gas detection main part according to the embodiment of the present disclosure;

FIG. 5A is a first schematic perspective view illustrating a base according to an embodiment of the present disclosure;

FIG. 5B is a second schematic perspective view illustrating the base according to the embodiment of the present disclosure;

FIG. 6 is a third schematic view illustrating the base according to the embodiment of the present disclosure;

FIG. 7A is a schematic exploded view illustrating a piezoelectric actuator and the base according to an embodiment of the present disclosure;

FIG. 7B is a schematic perspective view illustrating the combination of the piezoelectric actuator and the base according to the embodiment of the present disclosure;

FIG. 8A is a first schematic exploded view illustrating the piezoelectric actuator according to the embodiment of the present disclosure;

FIG. 8B is a second schematic exploded view illustrating the piezoelectric actuator according to the embodiment of the present disclosure;

FIG. 9A is a first schematic cross-sectional view illustrating the first operation step of the piezoelectric actuator according to the embodiment of the present disclosure;

FIG. 9B is a second schematic cross-sectional view illustrating the second operation step of the piezoelectric actuator according to the embodiment of the present disclosure;

FIG. 9C is a third schematic cross-sectional view illustrating the third operation step of the piezoelectric actuator according to the embodiment of the present disclosure;

FIG. 10A is a first schematic cross-sectional view illustrating the gas detection main part according to the embodiment of the present disclosure;

FIG. 10B is a second schematic cross-sectional view illustrating the gas detection main part according to the embodiment of the present disclosure;

FIG. 10C is a third schematic cross-sectional view illustrating the gas detection main part according to the embodiment of the present disclosure; and

FIG. 11 is a block diagram showing the signal transmission of the gas detection device according to an embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present disclosure provides a method for detecting and cleaning air pollution which is applied for detecting and cleaning an air pollution in an indoor space. The method includes the following steps.

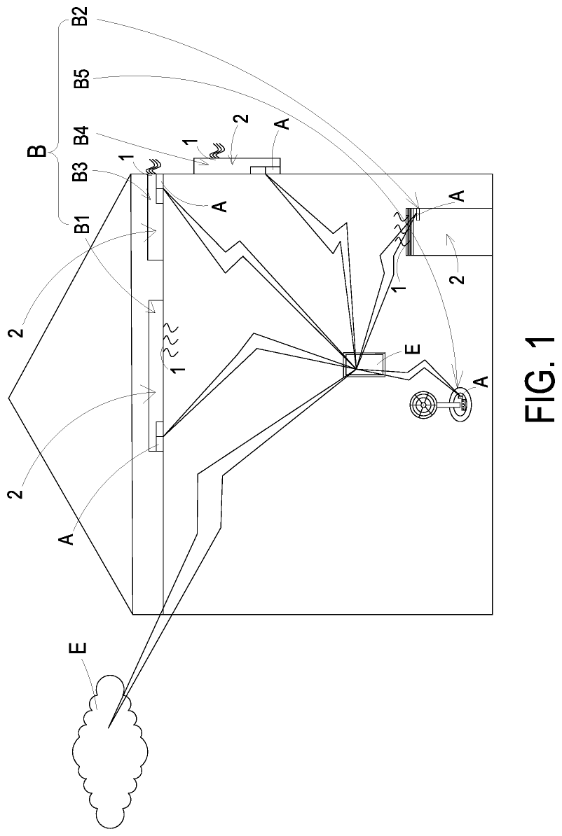

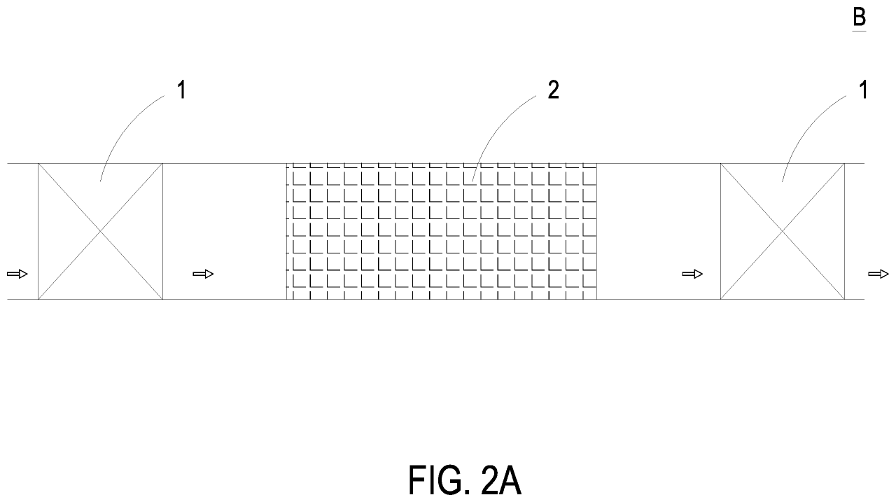

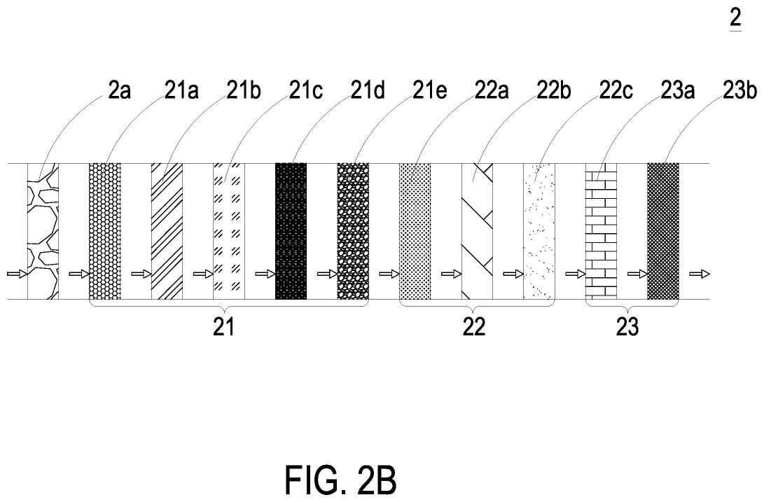

Please refer to FIG. 1, FIG. 2A and FIG. 2B. The first step is to provide a plurality of gas detection devices A disposed in the indoor space for detecting a property and a concentration of the air pollution. In the embodiment, the plurality of gas detection devices A detect the air pollution to output air pollution data, perform an intelligent computation to determine a location of the air pollution in the indoor space, and intelligently and selectively issue a controlling instruction.

The second step is to provide a plurality of physical filtration devices B or a plurality of chemical filtration devices B, and each of the plurality of physical filtration devices B or the plurality of chemical filtration devices B includes at least one fan 1 and at least one filter element 2. In this embodiment, the fan 1 receives the controlling instruction and is enabled thereby to generate a directional airflow convection through a mathematical operation for guiding the air pollution to pass through the filter element 2, so that the air pollution in the indoor space is filtered and cleaned to generate a clean and safely breathable air state.

Notably, in this embodiment, the air pollution is at least one selected from the group consisting of particulate matter, carbon monoxide, carbon dioxide, ozone, sulfur dioxide, nitrogen dioxide, lead, total volatile organic compounds (TVOC), formaldehyde, bacteria, fungi, virus and a combination thereof. Please refer to FIG. 2A. The plurality of gas detection devices A are disposed in the indoor space to detect the property and the concentration of the air pollution, and each of the gas detection devices A detects the air pollution to output air pollution data and perform an intelligent computation. The intelligent computation is performed through a cloud device E based on the air pollution data outputted from the plurality of gas detection devices A, so as to perform an artificial intelligence (AI) computation and a big data comparison to determine the location of the air pollution in the indoor space. Therefore, the controlling instruction is intelligently and selectively issued through a wireless communication transmission to enable the plurality of physical filtration devices B or the plurality of chemical filtration devices B. That is, the values of the air pollution data detected and provided by the gas detection devices A are compared through the intelligent computation for estimating the location of the air pollution, so that the controlling instruction is issued through the wireless communication transmission to enable the plurality of physical filtration devices B or the plurality of chemical filtration devices B. Preferably but not exclusively, each of the physical filtration devices B or the chemical filtration devices B includes at least one fan 1 and at least one filter element 2. The fan 1 is capable of inhaling or exhausting gas in dual directions. In an airflow path (whose direction is shown by the arrow), the fan 1 is disposed at the front side of the filter element 2, or the fan 1 is disposed at the rear side of the filter element 2. Alternatively, as shown in FIG. 2A, the fans 1 are arranged at the front and rear sides of the filter element 2. Certainly, in other embodiments, the arrangement of the fans 1 can be designed and is adjustable in accordance with the practical requirements.

Notably, the mathematical operation described herein means that after the air pollution data detected in the indoor space are received and compared by the plurality of gas detection devices A through the cloud device E, the air pollution data with the highest value is intelligently calculated and obtained to determine the location of the air pollution in the indoor space. Thereafter, the controlling instruction is intelligently and selectively issued to enable the physical filtration device B or the chemical filtration device B closest to the location of the air pollution, then the controlling instruction is intelligently and selectively issued to further enable the rest of the physical filtration devices B or the chemical filtration devices B to generate a directional airflow convection. Consequently, the flow of the air pollution is accelerated by the directional airflow convection to move toward the filter element 2 of the physical filtration device B or the chemical filtration device B closest to the location of the air pollution for being filtered and cleaned, and thus, the air pollution in the indoor space is filtered and cleaned to generate the clean and safely breathable air state. In other words, after the detected and outputted air pollution data from the plurality of gas detection devices A is received and calculated by the artificial intelligence (AI) operation and the big data comparison through the cloud device E, the fan 1 of the physical filtration device B or the chemical filtration device B which is closest to the location of the air pollution would receive the controlling instruction and is enabled thereby to generate an airflow first. Then, the controlling instruction is intelligently and selectively issued to the fans 1 of the rest of the physical filtration devices B or the rest of the chemical filtration devices B at positions farther from the location of the air pollution, and after receiving the controlling instruction, the fans 1 are also enabled to form a direction airflow convection. Accordingly, the flow of the air pollution is accelerated by the directional airflow convection to move toward the filter element 2 of the physical filtration device B or the chemical filtration device B closest to the location of the air pollution for being filtered and cleaned, so that the air pollution in the indoor space is filtered and cleaned to generate the clean and safely breathable air state.

Notably, what the air pollution is cleaned “completely” means that the air pollution is filtered and cleaned to reach a safe detection value, so as to generate the clean and safely breathable air state. In some embodiments, the safety detection value is zero. In some other embodiments, the safe detection value includes at least one selected from the group consisting of a concentration of PM_{2.5} which is less than 10 μg/m³, a concentration of carbon dioxide which is less than 1000 ppm, a concentration of total volatile organic compounds which is less than 0.56 ppm, a concentration of formaldehyde which is less than 0.08 ppm, a colony-forming unit of bacteria which is less than 1500 CFU/m³, a colony-forming unit of fungi which is less than 1000 CFU/m³, a concentration of sulfur dioxide which is less than 0.075 ppm, a concentration of nitrogen dioxide which is less than 0.1 ppm, a concentration of carbon monoxide which is less than 9 ppm, a concentration of ozone which is less than 0.06 ppm, and a concentration of lead which is less than 0.15 μg/m³.

Notably, in this embodiment, the physical filtration device B or the chemical filtration device B is, for example but not limited to, a fresh air fan B1, a purifier B2, an exhaust fan B3, a range hood B4 or an electric fan B5. Certainly, the type and/or the number of the physical filtration device B or the chemical filtration device B are not limited to be one. That is, the number of the filtration device B can be more than one.

Please refer to FIG. 2B. In this embodiment, the filter element 2 of the physical filtration device B is a filter screen which cleans the air pollution through physically blocking and absorbing. Preferably but not exclusively, the filter screen is a high efficiency particulate air (HEPA) filter screen 2a, which is configured to absorb the chemical smokes, bacteria, dust particles and pollens contained in the air pollution, so that the air pollution introduced into the filter element 2 is filtered and purified to achieve the effect of filtering and purification. In this embodiment, the filter element 2 of the chemical filtration device B cleans the air pollution chemically through coating a decomposition layer 21. Preferably but not exclusively, the decomposition layer 21 includes an activated carbon 21a, which is configured to remove the organic and inorganic substances in the air pollution and remove the colored and odorous substances. Preferably but not exclusively, the decomposition layer 21 includes a cleansing factor containing chlorine dioxide 21b, which is configured to inhibit viruses, bacteria, fungi, influenza A, influenza B, enterovirus and norovirus in the air pollution, and the inhibition ratio can reach 99%, thereby reducing the cross-infection of viruses. Preferably but not exclusively, the decomposition layer 21 includes an herbal protective layer 21c extracted from ginkgo and Japanese Rhus chinensis, which is configured to resist allergy effectively and destroy a surface protein of influenza virus (H1N1) passing therethrough. Preferably but not exclusively, the decomposition layer 21 includes a silver ion 21d, which is configured to inhibit viruses, bacteria and fungi contained in the air pollution. Preferably but not exclusively, the decomposition layer 21 includes a zeolite 21e, which is configured to remove ammonia nitrogen, heavy metals, organic pollutants, Escherichia coli, phenol, chloroform and anionic surfactants. In an embodiment, the filter element 2 of the chemical filtration device B is combined with a light irradiation element 22 to clean the air pollution chemically. Preferably but not exclusively, the light irradiation element 22 includes a photo-catalyst unit including a photo catalyst 22a and an ultraviolet lamp 22b. When the photo catalyst 22a is irradiated by the ultraviolet lamp 22b, the light energy is converted into the chemical energy to decompose harmful substances contained in the air pollution and disinfect bacteria contained in the air pollution, so as to achieve the effects of filtering and purifying. Preferably but not exclusively, the light irradiation element 22 includes a photo-plasma unit including a nanometer irradiation tube 22c. When the introduced air pollution is irradiated by the nanometer irradiation tube 22c, oxygen molecules and water molecules contained in the air pollution are decomposed into high oxidizing photo-plasma to generate an ion flow capable of destroying organic molecules, so that volatile formaldehyde, volatile toluene and volatile organic compounds (VOC) contained in the air pollution are decomposed into water and carbon dioxide, so as to achieve the effects of filtering and purifying. In an embodiment, the filter element 2 of the chemical filtration device B is combined with a decomposition unit 23 to clean the air pollution chemically. Preferably but not exclusively, the decomposition unit 23 includes a negative ion unit 23a which makes the suspended particles contained in the air pollution to carry with positive charges and adhered to a dust collecting plate carry with negative charges, so as to achieve the effects of filtering and purifying the introduced air pollution. Preferably but not exclusively, the decomposition unit 23 includes a plasma ion unit 23b. Through the plasma ions, the oxygen molecules and the water molecules contained in the air pollution are decomposed into positive hydrogen ions (H⁺) and negative oxygen ions (O₂⁻), and the substances attached with water around the ions are adhered on the surface of viruses and bacteria and converted into OH radicals with extremely strong oxidizing power, thereby removing hydrogen (H) from the protein on the surface of viruses and bacteria, and thus decomposing (oxidizing) the protein, so as to filter the introduced air pollution and achieve the effects of filtering and purifying.

Moreover, the method of the present disclosure can also further include a step of providing a cloud device E, as shown in FIG. 1. The intelligent computation is performed by the cloud device E based on the air pollution data outputted by the plurality of gas detection devices A to perform the artificial intelligence (AI) computation and the big data comparison, so as to determine the location of the air pollution in the indoor space, then the controlling instruction is intelligently and selectively issued and feedbacked to the physical filtration device B or the chemical filtration device B, so as to enable the physical filtration device B or the chemical filtration device B.

In order to elucidate the operation of the method of the present disclosure, the structure of the gas detection device A of the present disclosure is described in detail as follows.

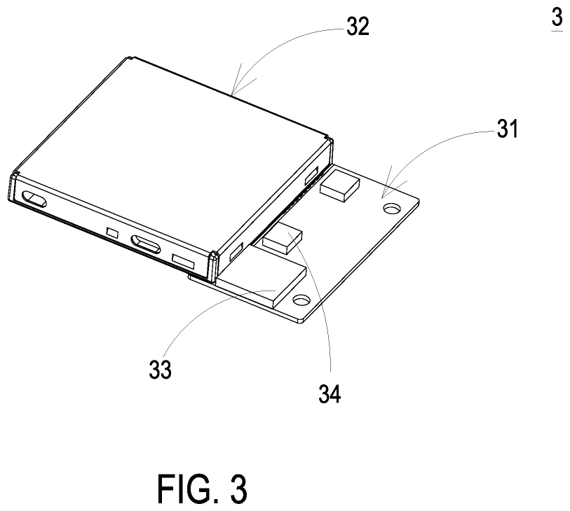

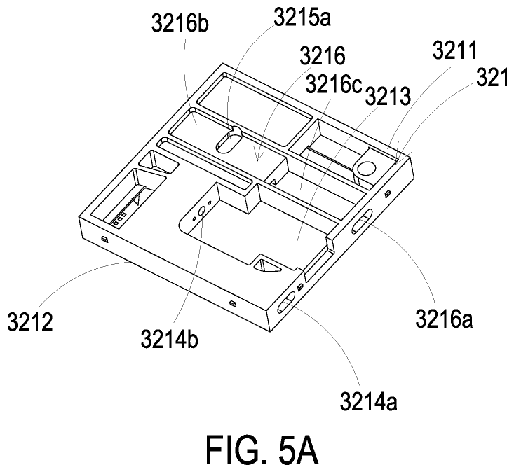

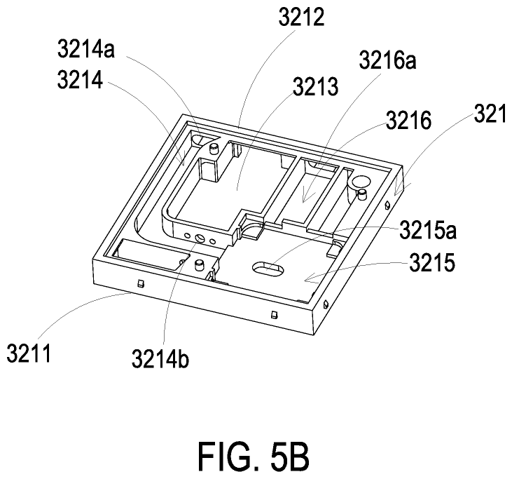

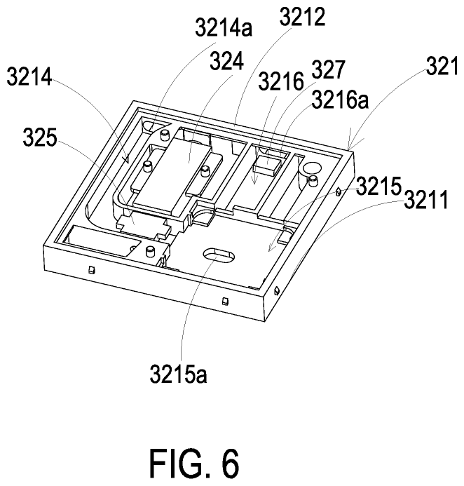

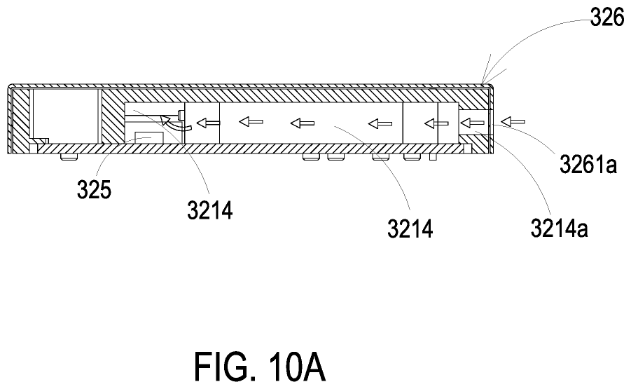

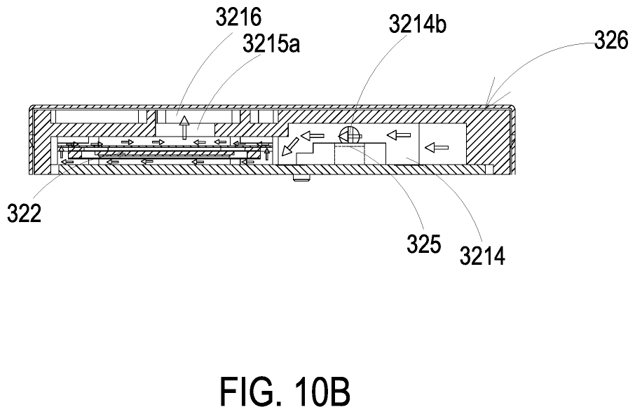

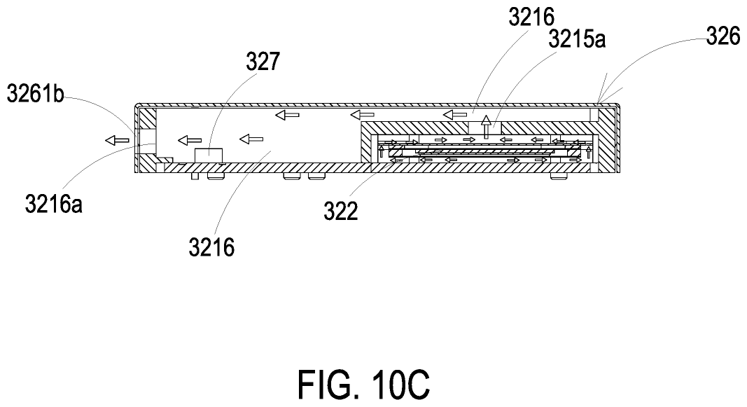

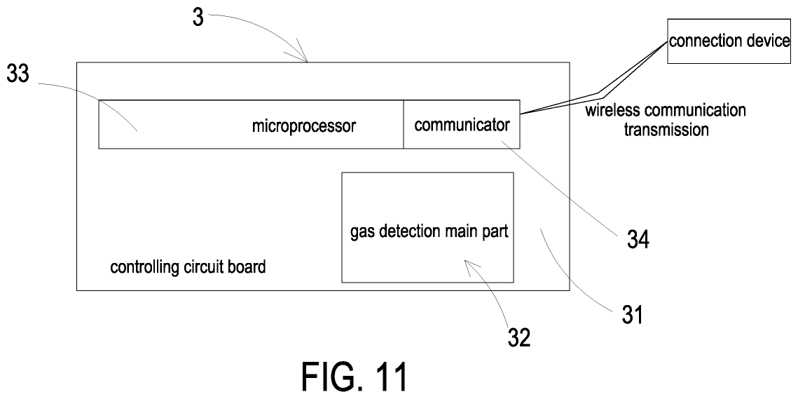

Please refer to FIG. 3 to FIG. 11. The gas detection device A is represented by reference numeral 3 in the following descriptions. In the embodiment, the gas detection device 3 includes a controlling circuit board 31, a gas detection main part 32, a microprocessor 33 and a communicator 34. The gas detection main part 32, the microprocessor 33 and the communicator 34 are integrally packaged on the controlling circuit board 31 and electrically connected to each other. Preferably but not exclusively, the microprocessor 33 and the communicator 34 are disposed on the controlling circuit board 31, and the microprocessor 33 controls a driving signal of the gas detection main part 32 to enable the detection. The gas detection main part 32 detects the air pollution and outputs a detection signal. The microprocessor 33 receives the detection signal for calculating, processing and outputting, so as to generate the air pollution data, which is provided to the communicator 34 for externally transmitting to a connected device through a wireless communication transmission. Preferably but not exclusively, the wireless communication transmission is one selected from the group consisting of a Wi-Fi communication transmission, a Bluetooth communication transmission, a radio frequency identification communication transmission and a near field communication (NFC) transmission.

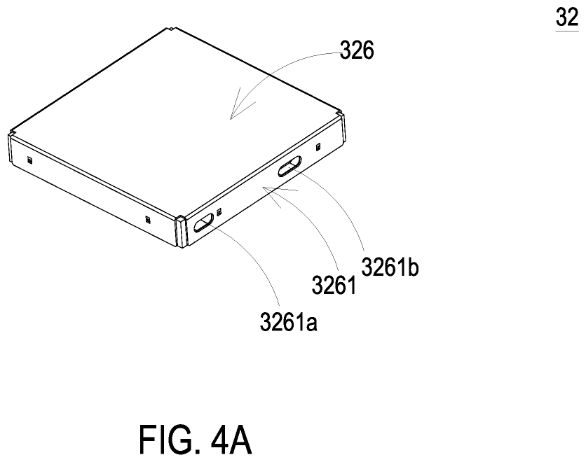

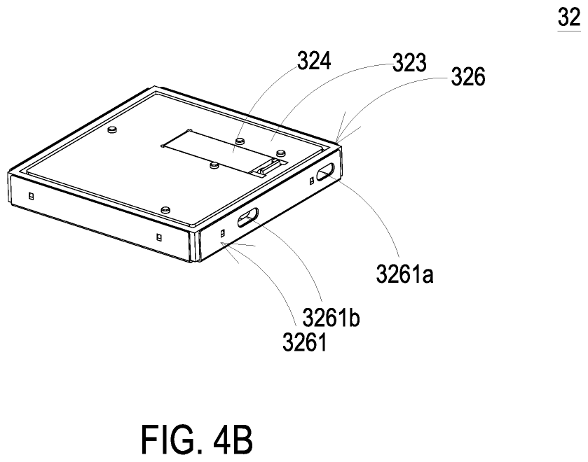

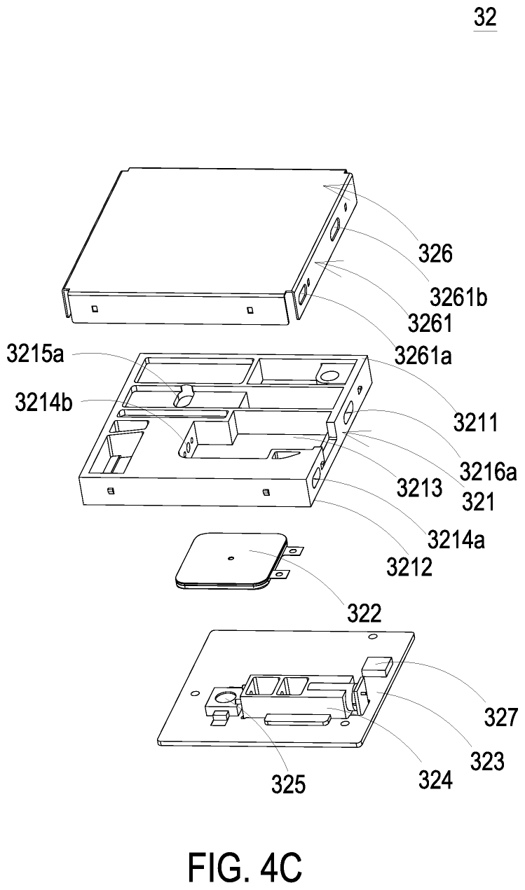

Please refer to FIG. 4A to FIG. 9A. The gas detection main part mentioned above 32 includes a base 321, a piezoelectric actuator 322, a driving circuit board 323, a laser component 324, a particulate sensor 325 and an outer cover 326. In the embodiment, the base 321 includes a first surface 3211, a second surface 3212, a laser loading region 3213, a gas-inlet groove 3214, a gas-guiding-component loading region 3215 and a gas-outlet groove 3216. The first surface 3211 and the second surface 3212 are two surfaces opposite to each other. In the embodiment, the laser loading region 3213 is hollowed out from the first surface 3211 toward the second surface 3212. The outer cover 326 covers the base 321 and includes a side plate 3261. The side plate 3261 has an inlet opening 3261a and an outlet opening 3261b. The gas-inlet groove 3214 is concavely formed from the second surface 3212 and disposed adjacent to the laser loading region 3213. The gas-inlet groove 3214 includes a gas-inlet 3214a and two lateral walls. The gas-inlet 3214a is in communication with the outside the base 321, and is spatially corresponding in position to an inlet opening 3261a of the outer cover 326. Two transparent windows 3214b are respectively opened on the two lateral walls of the gas-inlet groove 3214 and are in communication with the laser loading region 3213. Therefore, when the first surface 3211 of the base 321 is covered and attached by the outer cover 326, and the second surface 3212 is covered and attached by the driving circuit board 323, an inlet path is defined by the gas-inlet groove 3214.

In the embodiment, the gas-guiding-component loading region 3215 is concavely formed from the second surface 3212 and in communication with the gas-inlet groove 3214. A ventilation hole 3215a penetrates a bottom surface of the gas-guiding-component loading region 3215. The gas-guiding-component loading region 3215 includes four positioning protrusions 3215b disposed at four corners of the gas-guiding-component loading region 3215, respectively. In the embodiment, the gas-outlet groove 3216 mentioned above includes a gas-outlet 3216a, and the gas-outlet 3216a is spatially corresponding to the outlet opening 3261b of the outer cover 326. The gas-outlet groove 3216 includes a first section 3216b and a second section 3216c. The first section 3216b is concavely formed out from the first surface 3211 in a region spatially corresponding to a vertical projection area of the gas-guiding-component loading region 3215. The second section 3216c is hollowed out from the first surface 3211 to the second surface 3212 in a region where the first surface 3211 is extended from the vertical projection area of the gas-guiding-component loading region 3215. The first section 3216b and the second section 3216c are connected to form a stepped structure. Moreover, the first section 3216b of the gas-outlet groove 3216 is in communication with the ventilation hole 3215a of the gas-guiding-component loading region 3215, and the second section 3216c of the gas-outlet groove 3216 is in communication with the gas-outlet 3216a. In that, when the first surface 3211 of the base 321 is attached and covered by the outer cover 326 and the second surface 3212 of the base 321 is attached and covered by the driving circuit board 323, the gas-outlet groove 3216 and the driving circuit board 323 collaboratively define an outlet path.

In the embodiment, the laser component 324 and the particulate sensor 325 mentioned above are disposed on and electrically connected to the driving circuit board 323 and located within the base 321. In order to clearly describe and illustrate the positions of the laser component 324 and the particulate sensor 325 in the base 321, the driving circuit board 323 is intentionally omitted. The laser component 324 is accommodated in the laser loading region 3213 of the base 321, and the particulate sensor 325 is accommodated in the gas-inlet groove 3214 of the base 321 and is aligned to the laser component 324. In addition, the laser component 324 is spatially corresponding to the transparent window 3214b. Therefore, a light beam emitted by the laser component 324 passes through the transparent window 3214b and irradiates into the gas-inlet groove 3214. A light beam path from the laser component 324 passes through the transparent window 3214b and extends in an orthogonal direction perpendicular to the gas-inlet groove 3214. In the embodiment, the projecting light beam emitted from the laser component 324 passes through the transparent window 3214b and enters the gas-inlet groove 3214 to irradiate the suspended particles contained in the gas passing through the gas-inlet groove 3214. When the suspended particles contained in the gas are irradiated and generate scattered light spots, the scattered light spots are detected and calculated by the particulate sensor 325, which is in an orthogonal direction perpendicular to the gas-inlet groove 3214, to obtain the gas detection information. In the embodiment, a gas sensor 327 is positioned and disposed on the driving circuit board 323, electrically connected to the driving circuit board 323, and accommodated in the gas-outlet groove 3216, so as to detect the air pollution introduced into the gas-outlet groove 3216. Preferably but not exclusively, in an embodiment, the gas sensor 327 includes a volatile-organic-compound sensor for detecting the gas information of carbon dioxide (CO₂) or volatile organic compounds (TVOC). Preferably but not exclusively, in an embodiment, the gas sensor 327 includes a formaldehyde sensor for detecting the gas information of formaldehyde (HCHO). Preferably but not exclusively, in an embodiment, the gas sensor 327 includes a bacteria sensor for detecting the gas information of bacteria or fungi. Preferably but not exclusively, in an embodiment, the gas sensor 327 includes a virus sensor for detecting the gas information of virus.

In the embodiment, the piezoelectric actuator 322 mentioned above is accommodated in the square-shaped gas-guiding-component loading region 3215 of the base 321. In addition, the gas-guiding-component loading region 3215 of the base 321 is in communication with the gas-inlet groove 3214. When the piezoelectric actuator 322 is enabled, the gas in the gas-inlet 3214 is inhaled into the piezoelectric actuator 322 and flows through the ventilation hole 3215a of the gas-guiding-component loading region 3215 into the gas-outlet groove 3216. Moreover, the driving circuit board 323 mentioned above covers the second surface 3212 of the base 321, and the laser component 324 is positioned and disposed on the driving circuit board 323, and is electrically connected to the driving circuit board 323. The particulate sensor 325 is also positioned and disposed on the driving circuit board 323, and is electrically connected to the driving circuit board 323. In that, when the outer cover 326 covers the base 321, the inlet opening 3261a is spatially corresponding to the gas-inlet 3214a of the base 321, and the outlet opening 3261b is spatially corresponding to the gas-outlet 3216a of the base 321.

In the embodiment, the piezoelectric actuator 322 mentioned above includes a gas-injection plate 3221, a chamber frame 3222, an actuator element 3223, an insulation frame 3224 and a conductive frame 3225. In the embodiment, the gas-injection plate 3221 is made by a flexible material and includes a suspension plate 3221a and a hollow aperture 3221b. The suspension plate 3221a is a sheet structure and is permitted to undergo a bending deformation. Preferably but not exclusively, the shape and the size of the suspension plate 3221a are corresponding to the inner edge of the gas-guiding-component loading region 3215, but not limited thereto. The hollow aperture 3221b passes through a center of the suspension plate 3221a, so as to allow the gas to flow therethrough. Preferably but not exclusively, in the embodiment, the shape of the suspension plate 3221a is selected from the group consisting of a square, a circle, an ellipse, a triangle and a polygon, but not limited thereto.

In the embodiment, the chamber frame 3222 mentioned above is carried and stacked on the gas-injection plate 3221. In addition, the shape of the chamber frame 3222 is corresponding to the gas-injection plate 3221. The actuator element 3223 is carried and stacked on the chamber frame 3222 so as to collaboratively define a resonance chamber 3226 with the chamber frame 3222 and the suspension plate 3221a therebetween. The insulation frame 3224 is carried and stacked on the actuator element 3223 and the appearance of the insulation frame 3224 is similar to that of the chamber frame 3222. The conductive frame 3225 is carried and stacked on the insulation frame 3224, and the appearance of the conductive frame 3225 is similar to that of the insulation frame 3224. In addition, the conductive frame 3225 includes a conducting pin 3225a and a conducting electrode 3225b. The conducting pin 3225a is extended outwardly from an outer edge of the conductive frame 3225, and the conducting electrode 3225b is extended inwardly from an inner edge of the conductive frame 3225. Moreover, the actuator element 3223 further includes a piezoelectric carrying plate 3223a, an adjusting resonance plate 3223b and a piezoelectric plate 3223c. The piezoelectric carrying plate 3223a is carried and stacked on the chamber frame 3222. The adjusting resonance plate 3223b is carried and stacked on the piezoelectric carrying plate 3223a. The piezoelectric plate 3223c is carried and stacked on the adjusting resonance plate 3223b. The adjusting resonance plate 3223b and the piezoelectric plate 3223c are accommodated in the insulation frame 3224. The conducting electrode 3225b of the conductive frame 3225 is electrically connected to the piezoelectric plate 3223c. In the embodiment, the piezoelectric carrying plate 3223a and the adjusting resonance plate 3223b are made by a conductive material. The piezoelectric carrying plate 3223a includes a piezoelectric pin 3223d. The piezoelectric pin 3223d and the conducting pin 3225a are electrically connected to a driving circuit (not shown) of the driving circuit board 323, so as to receive a driving signal, such as a driving frequency and a driving voltage. Through this structure, a circuit is formed by the piezoelectric pin 3223d, the piezoelectric carrying plate 3223a, the adjusting resonance plate 3223b, the piezoelectric plate 3223c, the conducting electrode 3225b, the conductive frame 3225 and the conducting pin 3225a for transmitting the driving signal. Moreover, the insulation frame 3224 provides insulation between the conductive frame 3225 and the actuator element 3223, so as to avoid the occurrence of a short circuit. Thereby, the driving signal is transmitted to the piezoelectric plate 3223c. After receiving the driving signal, the piezoelectric plate 3223c deforms due to the piezoelectric effect, and the piezoelectric carrying plate 3223a and the adjusting resonance plate 3223b are further driven to generate the bending deformation in the reciprocating manner.

Furthermore, in the embodiment, the adjusting resonance plate 3223b is located between the piezoelectric plate 3223c and the piezoelectric carrying plate 3223a and served as a cushion between the piezoelectric plate 3223c and the piezoelectric carrying plate 3223a. Thereby, the vibration frequency of the piezoelectric carrying plate 3223a is adjustable. Basically, the thickness of the adjusting resonance plate 3223b is greater than the thickness of the piezoelectric carrying plate 3223a, and the vibration frequency of the actuator element 3223 can be adjusted by adjusting the thickness of the adjusting resonance plate 3223b.

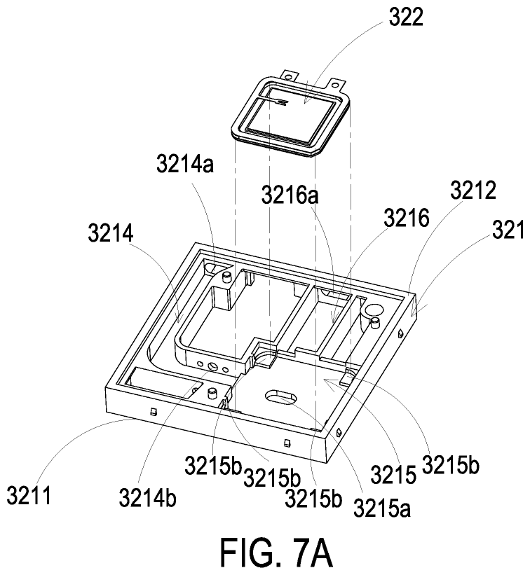

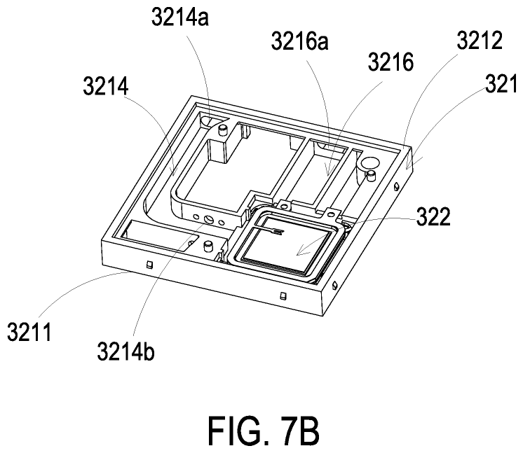

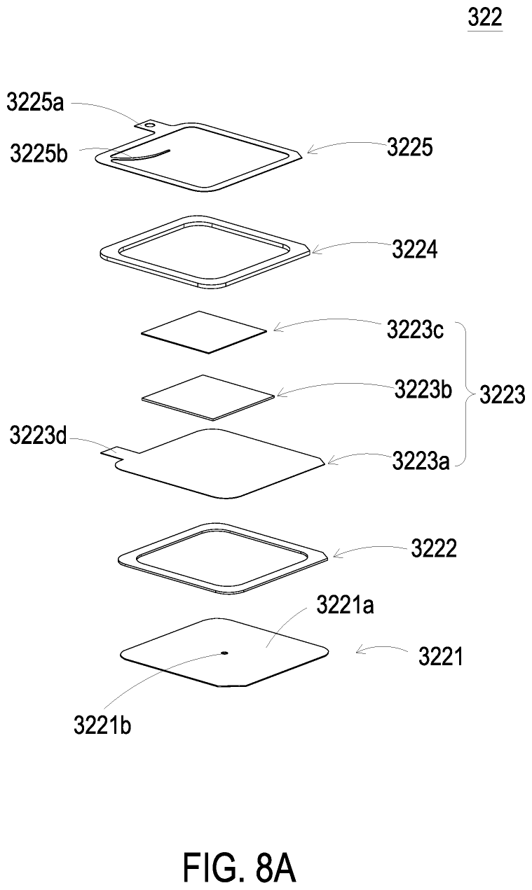

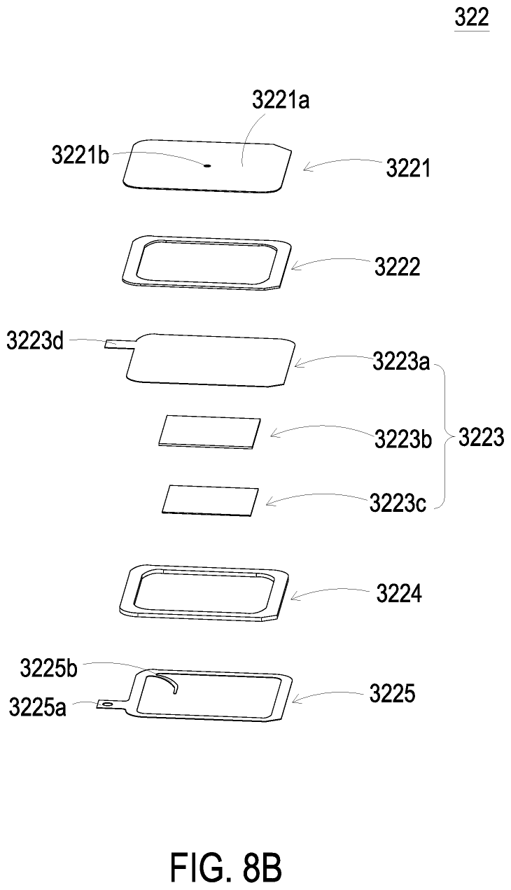

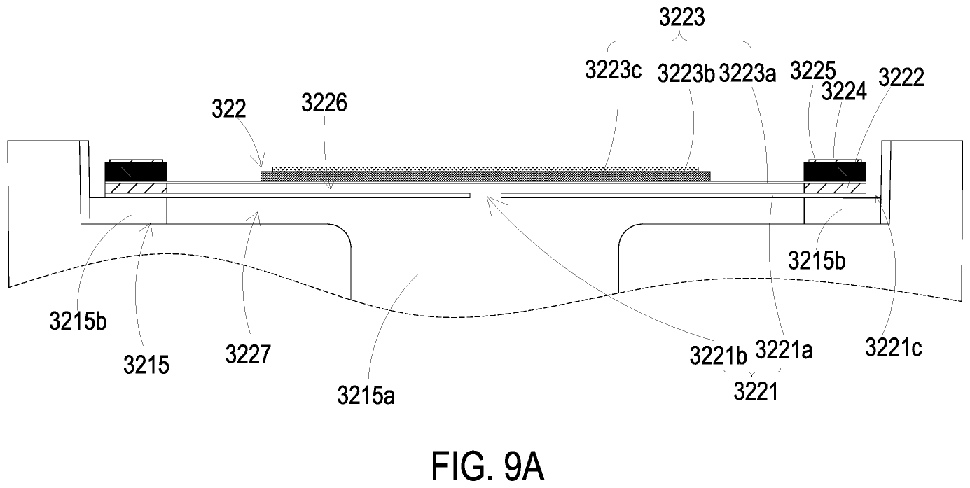

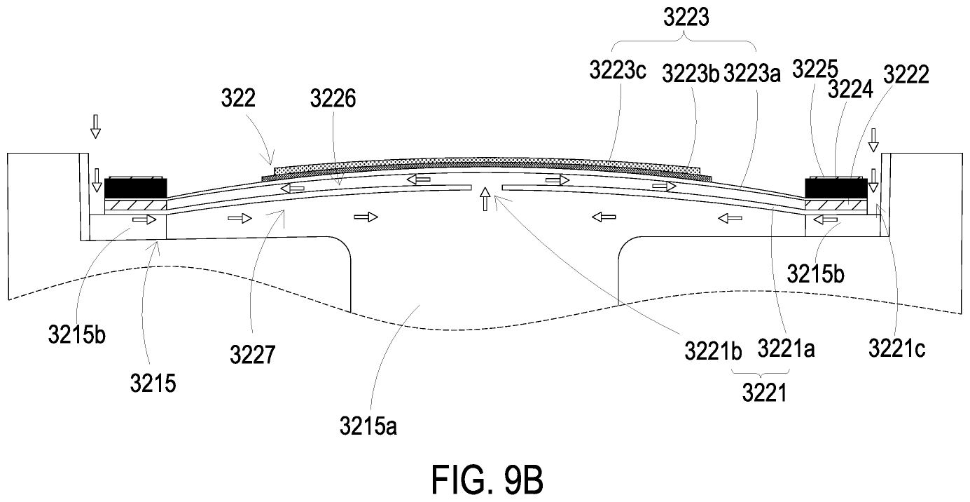

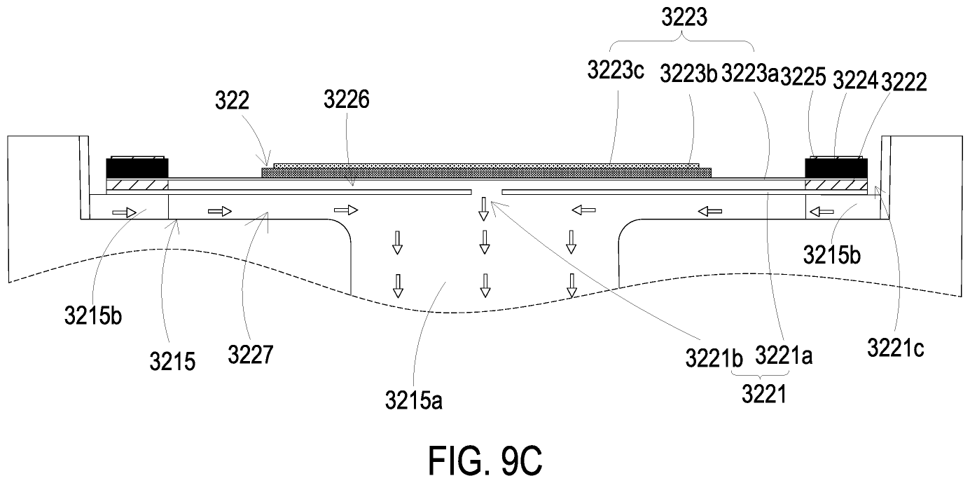

Please refer to FIG. 7A, FIG. 7B, FIG. 8A, FIG. 8B and FIG. 9A. In the embodiment, the gas-injection plate 3221, the chamber frame 3222, the actuator element 3223, the insulation frame 3224 and the conductive frame 3225 are stacked and positioned in the gas-guiding-component loading region 3215 sequentially, so that the piezoelectric actuator 322 is supported and positioned in the gas-guiding-component loading region 3215. A plurality of clearances 3221c are defined between the suspension plate 3221a of the gas-injection plate 3221 and an inner edge of the gas-guiding-component loading region 3215 for gas flowing therethrough. In the embodiment, a flowing chamber 3227 is formed between the gas-injection plate 3221 and the bottom surface of the gas-guiding-component loading region 3215. The flowing chamber 3227 is in communication with the resonance chamber 3226 between the actuator element 3223, the chamber frame 3222 and the suspension plate 3221a through the hollow aperture 3221b of the gas-injection plate 3221. By controlling the vibration frequency of the gas in the resonance chamber 3226 to be close to the vibration frequency of the suspension plate 3221a, the Helmholtz resonance effect is generated between the resonance chamber 3226 and the suspension plate 3221a, so as to improve the efficiency of gas transportation. When the piezoelectric plate 3223c is moved away from the bottom surface of the gas-guiding-component loading region 3215, the suspension plate 3221a of the gas-injection plate 3221 is driven to move away from the bottom surface of the gas-guiding-component loading region 3215 by the piezoelectric plate 3223c. In that, the volume of the flowing chamber 3227 is expanded rapidly, the internal pressure of the flowing chamber 3227 is decreased to form a negative pressure, and the gas outside the piezoelectric actuator 322 is inhaled through the clearances 3221c and enters the resonance chamber 3226 through the hollow aperture 3221b. Consequently, the pressure in the resonance chamber 3226 is increased to generate a pressure gradient. When the suspension plate 3221a of the gas-injection plate 3221 is driven by the piezoelectric plate 3223c to move toward the bottom surface of the gas-guiding-component loading region 3215, the gas in the resonance chamber 3226 is discharged out rapidly through the hollow aperture 3221b, and the gas in the flowing chamber 3227 is compressed, so that the converged gas is quickly and massively ejected out of the flowing chamber 3227 under the condition close to an ideal gas state of the Benulli's law, and transported to the ventilation hole 3215a of the gas-guiding-component loading region 3215.

By repeating the above operation steps shown in FIG. 9B and FIG. 9C, the piezoelectric plate 3223c is driven to generate the bending deformation in a reciprocating manner. According to the principle of inertia, since the gas pressure inside the resonance chamber 3226 is lower than the equilibrium gas pressure after the converged gas is ejected out, the gas is introduced into the resonance chamber 3226 again. Moreover, the vibration frequency of the gas in the resonance chamber 3226 is controlled to be close to the vibration frequency of the piezoelectric plate 3223c, so as to generate the Helmholtz resonance effect to achieve the gas transportation at high speed and in large quantities. The gas is inhaled through the inlet opening 3261a of the outer cover 326, flows into the gas-inlet groove 3214 of the base 321 through the gas-inlet 3214a, and is transported to the position of the particulate sensor 325. The piezoelectric actuator 322 is enabled continuously to inhale the gas into the inlet path, and facilitate the gas outside the gas detection device to be introduced rapidly, flow stably, and transported above the particulate sensor 325. At this time, a projecting light beam emitted from the laser component 324 passes through the transparent window 3214b to irritate the suspended particles contained in the gas flowing above the particulate sensor 325 in the gas-inlet groove 3214. When the suspended particles contained in the gas are irradiated and generate scattered light spots, the scattered light spots are detected and calculated by the particulate sensor 325 for obtaining related information about the sizes and the concentration of the suspended particles contained in the gas. Moreover, the gas above the particulate sensor 325 is continuously driven and transported by the piezoelectric actuator 322, flows through the ventilation hole 3215a of the gas-guiding-component loading region 3215, and is transported to the gas-outlet groove 3216. At last, after the gas flows into the gas outlet groove 3216, the gas is continuously transported into the gas-outlet groove 3216 by the piezoelectric actuator 322, and thus the gas in the gas-outlet groove 3216 is pushed to discharge through the gas-outlet 3216a and the outlet opening 3261b.

In the present disclosure, the gas detection device A detects not only the suspended particles in the gas, but also the properties of the introduced gas, for example, for identifying the gas as formaldehyde, ammonia, carbon monoxide, carbon dioxide, oxygen or ozone. Therefore, the gas detection device A of the present disclosure further includes a gas sensor 327. Preferably but not exclusively, the gas sensor 327 is positioned and electrically connected to the driving circuit board 323, and is accommodated in the gas outlet groove 3216, so as to detect the concentration or the property of the volatile organic compound contained in the gas exhausted out through the outlet path.

In summary, the present disclosure provides a method for detecting and cleaning indoor air pollution. After widely disposing a plurality of gas detection devices to identify the property, the concentration and the location of the air pollution, and performing various mathematical operations and artificial intelligence operations with a cloud device through wired and wireless networks to determine the location of the air pollution, the physical filtration device or the chemical filtration device closest to the location of the air pollution is intelligently selected and enabled to generate an airflow, such that the air pollution is quickly guided to at least one physical filtration device or at least one chemical filtration device for being filtered and cleaned, thereby generating a clean and safely breathable air state. As a result, the effects of air pollution-locating, air pollution-draining and air pollution-cleaning can be achieved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for detecting and cleaning indoor air pollution, comprising:
providing a plurality of gas detection devices disposed in an indoor space for detecting a property and a concentration of an air pollution, wherein the plurality of gas detection devices detect the air pollution to output air pollution data, perform an intelligent computation to determine a location of the air pollution in the indoor space, and intelligently and selectively issue a controlling instruction; and
providing a plurality of physical filtration devices or a plurality of chemical filtration devices, each of the plurality of physical filtration devices or the plurality of chemical filtration devices comprising at least one fan and at least one filter element, wherein the fan is enabled by the controlling instruction through performing a mathematical operation so as to generate a directional airflow convection for guiding the air pollution to pass through the filter element, thereby filtering and cleaning the air pollution in the indoor space to generate a clean and safely breathable air state.

2. The method for detecting and cleaning indoor air pollution according to claim 1, wherein the air pollution is at least one selected from the group consisting of particulate matter, carbon monoxide, carbon dioxide, ozone, sulfur dioxide, nitrogen dioxide, lead, total volatile organic compounds (TVOC), formaldehyde, bacteria, fungi, virus and a combination thereof.

3. The method for detecting and cleaning indoor air pollution according to claim 1, wherein the intelligent computation is performed through an artificial intelligence (AI) computation and a big data comparison by a cloud device based on the air pollution data outputted by the plurality of gas detection devices to determine the location of the air pollution in the indoor space, so that the controlling instruction is intelligently and selectively issued through a wireless communication transmission to enable the plurality of physical filtration devices or the plurality of chemical filtration devices.

4. The method for detecting and cleaning indoor air pollution according to claim 3, wherein the mathematical operation comprises receiving and comparing the detected air pollution data in the indoor space by the plurality of gas detection devices through connecting to the cloud device, and intelligently calculating to obtain the air pollution data with a highest value thereamong so as to determine the location of the air pollution in the indoor space, and wherein the controlling instruction is intelligently and selectively issued to enable the physical filtration device or the chemical filtration device closest to the location of the air pollution, and then the controlling instruction is intelligently and selectively issued to further enable the rest of the physical filtration devices or the chemical filtration devices to generate the directional airflow convection for accelerating a flow of the air pollution to move toward the filter element of the physical filtration device or the chemical filtration device closest to the location of the air pollution for being filtered and cleaned, thereby filtering and cleaning the air pollution in the indoor space to generate the clean and safely breathable air state.

5. The method for detecting and cleaning indoor air pollution according to claim 1, wherein the filter element of the physical filtration device is a filter screen which cleans the air pollution through physically blocking and absorbing.

6. The method for detecting and cleaning indoor air pollution according to claim 5, wherein the filter screen is a high efficiency particulate air (HEPA) filter screen.

7. The method for detecting and cleaning indoor air pollution according to claim 1, wherein the filter element of the chemical filtration devices chemically cleans the air pollution through coating a decomposition layer.

8. The method for detecting and cleaning indoor air pollution according to claim 7, wherein the decomposition layer comprises one selected from the group consisting of an activated carbon, a cleansing factor containing chlorine dioxide and a combination thereof.

9. The method for detecting and cleaning indoor air pollution according to claim 7, wherein the decomposition layer comprises an herbal protective layer extracted from ginkgo and Japanese Rhus chinensis.

10. The method for detecting and cleaning indoor air pollution according to claim 7, wherein the decomposition layer comprises one selected from the group consisting of a sliver ion, a zeolite and a combination thereof.

11. The method for detecting and cleaning indoor air pollution according to claim 1, wherein the filter element of the chemical filtration device chemically cleans the air pollution through a combination of the filter element and a light irradiation element.

12. The method for detecting and cleaning indoor air pollution according to claim 11, wherein the light irradiation element is one selected from the group consisting of a photo-catalyst unit comprising a photo catalyst and an ultraviolet lamp, a photo-plasma unit comprising a nanometer irradiation tube and a combination thereof.

13. The method for detecting and cleaning indoor air pollution according to claim 1, wherein the filter element of the chemical filtration device chemically cleans the air pollution through a combination of the filter element and a decomposition unit.

14. The method for detecting and cleaning indoor air pollution according to claim 13, wherein the decomposition unit is one selected from the group consisting of a negative ion unit, a plasma ion unit and a combination thereof.

15. The method for detecting and cleaning indoor air pollution according to claim 1, wherein the gas detection device comprises a controlling circuit board, a gas detection main part, a microprocessor and a communicator, and the gas detection main part, the microprocessor and the communicator are integrally packaged on the controlling circuit board and electrically connected to the controlling circuit board, and wherein the microprocessor controls a detection operation of the gas detection main part, the gas detection main part detects the air pollution and outputs a detection signal, and the microprocessor receives the detection signal for calculating, processing and outputting to generate the air pollution data and provide the air pollution data to the communicator for performing a wireless communication transmission externally.

16. The method for detecting and cleaning indoor air pollution according to claim 15, wherein the wireless communication transmission is one selected from the group consisting of a Wi-Fi communication transmission, a Bluetooth communication transmission, a radio frequency identification communication transmission and a near field communication (NFC) transmission.

17. The method for detecting and cleaning indoor air pollution according to claim 15, wherein the gas detection main part comprises:
a base comprising:
a first surface;
a second surface opposite to the first surface;
a laser loading region hollowed out from the first surface to the second surface;
a gas-inlet groove concavely formed from the second surface and disposed adjacent to the laser loading region, wherein the gas-inlet groove comprises a gas-inlet and two lateral walls, and a transparent window is respectively opened on the two lateral walls for being in communication with the laser loading region;
a gas-guiding-component loading region concavely formed from the second surface and being in communication with the gas-inlet groove, wherein a ventilation hole penetrates a bottom surface of the gas-guiding-component loading region; and
a gas-outlet groove concavely formed from the first surface, spatially corresponding to the bottom surface of the gas-guiding-component loading region, and hollowed out from the first surface to the second surface in a region where the first surface is misaligned with the gas-guiding-component loading region, wherein the gas-outlet groove is in communication with the ventilation hole and is provided with a gas-outlet;
a piezoelectric actuator accommodated in the gas-guiding-component loading region;
a driving circuit board covering and attached to the second surface of the base;
a laser component positioned and disposed on the driving circuit board, electrically connected to the driving circuit board, and accommodated in the laser loading region, wherein a light beam path emitted from the laser component passes through the transparent window and extends in a orthogonal direction perpendicular to the gas-inlet groove;
a particulate sensor positioned and disposed on the driving circuit board, electrically connected to the driving circuit board, and accommodated in the gas-inlet groove at a position where the gas-inlet groove intersects the light beam path of the laser component in an orthogonal direction, for detecting suspended particulates contained in the air pollution passing through the gas-inlet groove and irradiated by a projecting light beam emitted from the laser component;
a gas sensor positioned and disposed on the driving circuit board, electrically connected to the driving circuit board, and accommodated in the gas-outlet groove, so as to detect the air pollution introduced into the gas-outlet groove; and
an outer cover covering the base and comprising a side plate, wherein the side plate has an inlet opening and an outlet opening, the inlet opening is spatially corresponding to the gas-inlet of the base, and the outlet opening is spatially corresponding to the gas-outlet of the base;
wherein the outer cover covers the base, and the driving circuit board covers the second surface, so that an inlet path is defined by the gas-inlet groove, and an outlet path is defined by the gas-outlet groove, and wherein the air pollution outside the base is inhaled by the piezoelectric actuator, transported into the inlet path defined by the gas-inlet groove through the inlet opening, and passes through the particulate sensor for detecting the particle concentration of the suspended particles contained in the air pollution, and the air pollution is further transported to the outlet path defined by the gas-outlet groove through the ventilation hole, passes through the gas sensor for detecting, and then discharged through the outlet opening.

18. The method for detecting and cleaning indoor air pollution according to claim 17, wherein the particulate sensor detects information of suspended particulates.

19. The method for detecting and cleaning indoor air pollution according to claim 17, wherein the gas sensor comprises a volatile-organic-compound sensor for detecting information of carbon dioxide or total volatile organic compounds in the gas.

20. The method for detecting and cleaning indoor air pollution according to claim 17, wherein the gas sensor is one selected from the group consisting of a formaldehyde sensor, a bacteria sensor and a combination thereof, and wherein the formaldehyde sensor detects information of formaldehyde in the gas, and the bacteria sensor detects information of bacteria or fungi in the gas.

21. The method for detecting and cleaning indoor air pollution according to claim 17, wherein the gas sensor comprises a virus sensor for detecting information of viruses in the gas.
